(19) United States
(12) Patent Application Publication
(10) Pub. No.: US 2004/0122899 A1
(43) Pub. Date: Jun. 24, 2004

(54) Content distribution system and content distribution method

(75) Inventor: Takahiro Ohkuma, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, Tokyo (JP)

(21) Appl. No.: 10/730,934

(22) Filed: Dec. 10, 2003

(30) Foreign Application Priority Data
Dec. 18, 2002 (JP) 2002-365987

(51) Int. Cl. G06F 15/16

(52) U.S. Cl. 709/205

(57) ABSTRACT

To provide a content distribution system that can distribute contents without selecting a content distribution method according to the number of receivers. Programs are associated with VLAN (Virtual Local Area Network) numbers indicating VLANs respectively. A broadcasting station distributes the programs using a broadcast model based on Layer 2 switches and the VLANs An information device belongs to the VLAN based on the VLAN number specified by a user to receive the user-desired program. Therefore, contents can be distributed without depending on the number of receivers.

### BACKGROUND OF THE INVENTION

1. Field of the Invention

The present invention relates to a content distribution system and a content distribution method, and more particularly to a content distribution system in which a broadcast-type service is performed on the Internet.

2. Description of the Related Art

Conventionally, in a content distribution system, if a broadcast-type service, which distributes contents on the Internet, is performed, IP (Internet Protocol) multicast is used (for example, refer to Japanese Patent Laid-Open No. 2002-118841).

In the above-described content distribution system, as described in Japanese Patent Laid-Open No. 2002-118841, a digital content distribution apparatus assigns an IP multicast address to the digital contents of each program and converts the contents into Ethernet frames. Subsequently, without specifying a digital content receiving apparatus at a distribution target, the digital content distribution apparatus transmits (broadcasts) the Ethernet frames to an IP multicast-capable selection/transfer apparatus using its hardware multicast address.

When receiving a receiving request, in which an IP multicast address is specified, from a digital content receiving apparatus, the IP multicast-capable selection/transfer apparatus selects Ethernet frames assigned with the IP multicast address from that that are broadcasted, and then transfers them to the digital content receiving apparatus.

However, in the above-described conventional content distribution system, there is a problem, in which there are a plurality of IP multicast protocols and an IP multicast protocol to be used depends on the number of receivers, so that it is necessary that each of relay nodes is implemented with the plurality of IP multicast protocols and selects the IP multicast protocol according to the number of receivers.

### SUMMARY OF THE INVENTION

It is therefore an object of the present invention to provide a content distribution system and a content distribution method, which can distribute contents without selecting a content distribution method according to the number of receivers.

A content distribution system according to the present invention is a content distribution system, which distributes contents from a broadcasting station to a receiving terminal on the Internet, comprising a Layer 2 switch and VLAN (Virtual Local Area Network) used for the distribution of the contents.

A content distribution method according to the present invention is a content distribution method for distributing contents from a broadcasting station to a receiving terminal on the Internet, wherein the distribution of the contents is performed using a broadcast model based on a Layer 2 switch and VLAN (Virtual Local Area Network).

That is, in a content distribution method according to the present invention in which a broadcast-type service is performed on the Internet, contents are distributed not using a conventional server & client model based on routers and IP (Internet Protocol) multicast but using a broadcast model based on Layer 2 switches and VLAN.

There exist a plurality of IP multicast protocols and it is necessary to select an appropriate IP multicast protocol according to the number of receivers. In the broadcast-type service, it is difficult to predict the number of receivers and it may greatly increase or decrease even during broadcasting, so that it is difficult to select an appropriate IP multicast protocol according to the number of receivers. Furthermore, at each of relay nodes, all of the plurality of IP multicast protocols must be supported. Generally, a router is more expensive than a Layer 2 switch.

In the content distribution method according to the present invention, contents are distributed not using routers but using a broadcast model with Layer 2 switches and VLAN, and the contents are associated with the VLAN number indicating the VLAN.

So as to set a TV (television) channel, each user sets the VLAN number associated with the user-desired contents to the Layer 2 interface of his/her information device to watch it. Thereby, a content distribution method without depending on the number of receivers can be realized.

More specifically, a content distribution system according to the present invention is a network, which comprises a broadcasting station, a plurality of Layer 2 switches and a plurality of user information devices. The broadcasting station distributes contents according to a program table. For example, between 10:00 and 11:00, a program A, a program B and a program C are broadcasted with “VLAN number=1”, “VLAN number=2” and “VLAN number=3” respectively.

Hereafter, the case where users R and S watch the program A between 10:00 and 11:00 will be considered. In the program table, the program A is associated with “VLAN number=1”. Therefore, to watch the program A, information devices of the users R and S are set up so as to belong to a VLAN indicated by the “VLAN number=1”. This allows the content distribution system according to the present invention to distribute contents with VLAN without depending on the number of receivers.

As described above, the content distribution system according to the present invention distributes contents using the broadcast model with VLAN, in which contents are associated with a VLAN number indicating VLAN and so as to set a TV channel, each user sets a VLAN number associated with user-desired contents to the Layer 2 interface of his/her information device to watch the user-desired contents. Thereby, the content distribution system according to the present invention can distribute contents without depending on the number of receivers.

### BRIEF DESCRIPTION OF THE DRAWINGS

FIG. 1 is a block diagram showing the configuration of a content distribution system according to a first embodiment of the present invention;

FIG. 2 is a figure showing the configuration of a program table used in the content distribution system according to the first embodiment of the present invention; and

FIG. 3 is a block diagram showing the configuration of a content distribution system according to a second embodiment of the present invention.

### DETAILED DESCRIPTION OF THE PREFERRED EMBODIMENTS

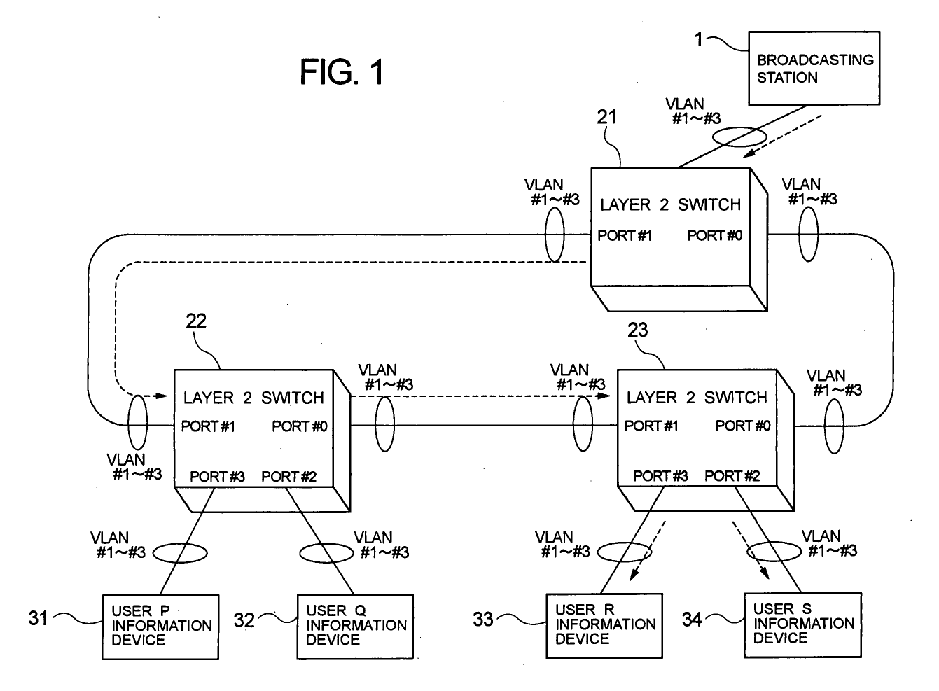

Referring to the drawings, embodiments of the present invention will be explained. FIG. 1 is a block diagram showing the configuration of a content distribution system according to a first embodiment of the present invention. In FIG. 1, the content distribution system according to the first embodiment of the present invention includes a broadcasting station 1, Layer 2 switches 21 to 23, and a user P information device 31 for enabling a user P to watch contents, a user Q information device 32 for enabling a user Q to watch contents, a user R information device 33 for enabling a user R to watch contents and a user S information device 34 for enabling a user S to watch contents. The content distribution system adopts a broadcast model based on the Layer 2 switches 21 to 23 and VLAN (Virtual Local Area Network).

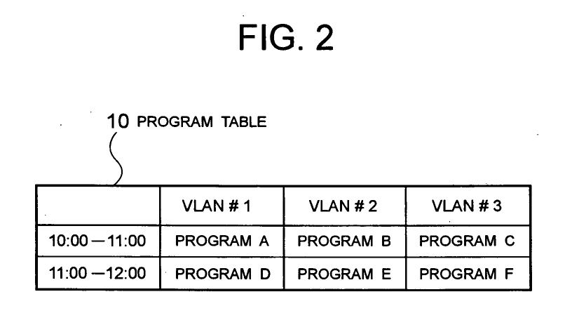

FIG. 2 shows the configuration of a program table used in the content distribution system according to the first embodiment of the present invention. In FIG. 2, a program table 10 describes that between 10:00 and 11:00 a program A, a program B and a program C are broadcasted with “VLAN number=VLAN#1”, “VLAN number=VLAN#2” and “VLAN number=VLAN#3” respectively.

In addition, the program table 10 also describes that between 11:00 and 12:00 a program D, a program E and a program F are broadcasted with “VLAN number=VLAN#1”, “VLAN number=VLAN#2” and “VLAN number=VLAN#3” respectively.

Referring to FIGS. 1 and 2, operations of the content distribution system according to the first embodiment of the present invention will be explained.

Based on the program table 10, the broadcasting station 1 outputs contents to the Layer 2 switch 21 as Ethernet frames. For example, in the case of the program A, contents are outputted as Ethernet frames with a tag of “VLAN number=VLAN#1”.

Each of the Layer 2 switches 21 to 23 transmits each of received Ethernet frames from a port belonging to a VLAN group specified by the VLAN number assigned to the frame. In this system, contents are distributed with VLAN#1, VLAN#2 and VLAN#3, so that ports Port#0 to Port#3 of each of the Layer 2 switches 21 to 23 are set into a group of VLAN#1, VLAN #2 and VLAN#3.

Next, the case where between 10:00 and 11:00 the users R and S watch the program A will be considered. Between 10:00 and 11:00, the broadcasting station 1 distributes the programs A, B and C.

First, the users R and S set their own information devices 33 and 34 so that the user R information device 33 and the user S information device 34 can receive Ethernet frames of “VLAN number=VLAN#1”.

Between 10:00 and 11:00, the broadcasting station 1 outputs the programs A, B and C with “VLAN number=VLAN#1”, “VLAN number=VLAN#2” and “VLAN number=VLAN#3” to the Layer 2 switch 21 respectively.

The Layer 2 switch 21 outputs the frames received from the broadcasting station 1 from the port Port#1, and then the outputted frames are received at the port Port#1 of the Layer 2 switch 22. Subsequently, the received frames are outputted from each of the ports Port#0, Port#2 and Port#3 of the Layer 2 switch 22.

Since the user P information device 31 and the user Q information device 32 are not set so as to receive the program A (Ethernet frames of “VLAN number=VLAN#1”), the frames outputted from the ports Port#2 and Port#3 of the Layer 2 switch 22 are not received by the user P information device 31 and the user Q information device 32.

The frames outputted from the port Port#0 of the Layer 2 switch 22 are received at the port Port#1 of the Layer 2 switch 23. The received frames are outputted from each of the ports Port#0, Port#2 and Port#3 of the Layer 2 switch 23.

The user R information device 33 and the user S information device 34 are set so as to receive the program A, that is, they are set so as to receive the frames of “VLAN number=VLAN#1”, so that they receive the frames outputted from the port Port#0 of the Layer 2 switch 22.

If the user Q wants to receive the program A, the user Q can watch it by only setting the user Q information device 32 so that the user Q information device 32 can receive the frames of “VLAN number=VLAN#1”.

In addition, a plurality of programs can also be watched simultaneously. For example, if the user Q wants to receive the programs A and C, the user Q can watch them by setting the user Q information device 32 so that the user Q information device 32 can receive the frames of “VLAN number=VLAN#1” and “VLAN number=VLAN#3”.

As described above, in the first embodiment, contents are associated with a VLAN number indicating a VLAN for distributing the contents, and contents are distributed using a broadcasting function of each of the Layer 2 switches 21 to 23, so that contents can be distributed without selecting a content distribution method according to the number of receivers.

In addition, in the first embodiment, the Layer 2 switches 21 to 23 having a broadcasting function are used for content distribution, so that contents can be distributed without expensive routers.

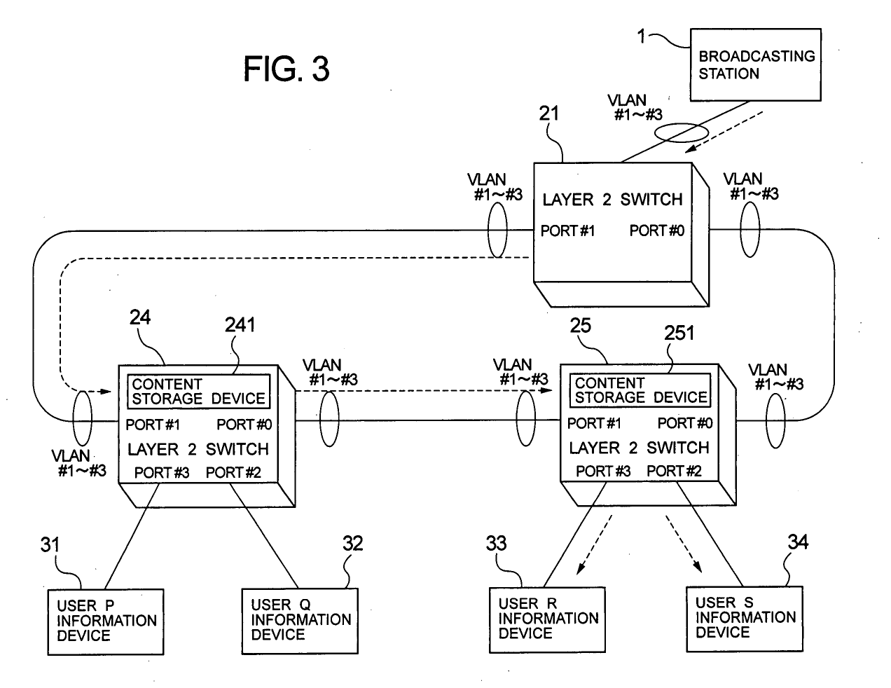

FIG. 3 is a block diagram showing the configuration of a content distribution system according to a second embodiment of the present invention. In FIG. 3, the content distribution system according to the second embodiment of the present invention has the same configuration of that according to the first embodiment of the present invention shown in FIG. 1 except using Layer 2 switches 24 and 25 having content storage devices (e.g., a hard disk device) 241 and 251 that store contents from the broadcasting station 1, and the same structure elements are attached with the same symbols. In addition, operations of the same structure elements are the same as that in the first embodiment of the present invention.

In the second embodiment, each of the information devices 31 to 34 downloads a user-desired program from the content storage device 241, 251 of the Layer 2 switch 24, 25 connected to the information device. Therefore, each of the users P, Q, R and S can watch the user-desired program.

Thereby, in the second embodiment, an effect is obtained, in which it is prevented that the traffic of undesired programs is inputted to the user P information device 31, the user Q information device 32, the user R information device 33 and the user S information device 34.

What is claimed is:

1. A content distribution system, which distributes contents from a broadcasting station to a receiving terminal on the Internet, comprising a Layer 2 switch and VLAN (Virtual Local Area Network) used for the distribution of the contents.

2. The content distribution system according to claim 1, wherein
said broadcasting station distributes the contents associated with the VLAN number of said VLAN to said Layer 2 switch and said VLAN.

3. The content distribution system according to claim 2, wherein
said receiving terminal receives the contents associated with the VLAN number by belonging to said VLAN based on the VLAN number.

4. The content distribution system according to claim 2, wherein
said Layer 2 switch includes storage means for storing the received contents associated with the VLAN number.

5. A content distribution method for distributing contents from a broadcasting station to a receiving terminal on the Internet, wherein
the distribution of the contents is performed using a broadcast model based on a Layer 2 switch and VLAN (Virtual Local Area Network).

6. The content distribution method according to claim 5, wherein
said broadcasting station distributes the contents associated with the VLAN number of said VLAN to said Layer 2 switch and said VLAN.

7. The content distribution method according to claim 6, wherein
said receiving terminal receives the contents associated with the VLAN number by belonging to said VLAN based on the VLAN number.

8. The content distribution method according to claim 6, wherein
the contents received from said broadcasting station and associated with the VLAN number are stored in storage means of said Layer 2 switch.
